(19) United States
(12) Patent Application Publication
(10) Pub. No.: US 2026/0230598 A1
(43) Pub. Date: Aug. 6, 2026

(54) CONTROL DEVICE AND STORAGE MEDIUM

(71) Applicant: TOYOTA JIDOSHA KABUSHIKI KAISHA, Toyota-shi (JP)

(72) Inventors: Yusuke TATESUMI, Seto-shi (JP); Tomoyasu Tamaoki, Okazaki-shi (JP); Yuko Takahira, Shizuoka-ken (JP)

(73) Assignee: TOYOTA JIDOSHA KABUSHIKI KAISHA, Toyota-shi (JP)

(21) Appl. No.: 19/447,146

(22) Filed: Jan. 13, 2026

(30) Foreign Application Priority Data
Feb. 6, 2025 (JP) 2025-018220

(51) Int. Cl. H04N 17/00; G06T 7/80; G07C 5/02; G06V 20/56

(52) U.S. Cl. CPC H04N 17/002; G06T 7/80; G07C 5/02; G06T 2207/30244; G06T 2207/30252; G06V 20/56

(57) ABSTRACT

A control device that performs attitude determination of a camera mounted on a vehicle is configured to determine an attitude of the vehicle, and not perform the attitude determination of the camera in a case where the attitude of the vehicle is a specific attitude. The specific attitude is an attitude in which an attitude of the camera with respect to the vehicle remains unchanged while the attitude of the camera with respect to a road surface changes.

### CROSS-REFERENCE TO RELATED APPLICATION

This application claims priority to Japanese Patent Application No. 2025-018220 filed on February 6, 2025. The disclosure of the above-identified application, including the specification, drawings, and claims, is incorporated by reference herein in its entirety.

### BACKGROUND

### 1. Technical Field

The present disclosure relates to a control device and a storage medium.

### 2. Description of Related Art

Japanese Unexamined Patent Application Publication No. 2015-191548 (JP 2015-191548 A) discloses a vehicle external monitoring device in which a vehicle-mounted camera is configured to determine whether an optical axis deviation of the vehicle-mounted camera occurs based on an image captured by the vehicle-mounted camera.

### SUMMARY

However, the vehicle external monitoring device in the related art described above does not consider a vehicle attitude. For example, determination may be made regarding whether the optical axis deviation of the vehicle-mounted camera occurs when the vehicle is being towed in a state where the front wheel or the rear wheel of the vehicle is lifted by a towing vehicle such as a tow truck. In this case, in the vehicle external monitoring device in the related art, an attitude of the vehicle-mounted camera with respect to a road surface may change even though an attitude of the vehicle-mounted camera with respect to the vehicle does not change. Therefore, there is a concern that the vehicle external monitoring device in the related art may erroneously determine that the optical axis deviation of the vehicle-mounted camera occurs even though the optical axis deviation of the vehicle-mounted camera does not occur.

The present disclosure has been made in view of such problems, and an object thereof is to suppress erroneous determination that an abnormality occurs even though an abnormality does not occur in an attitude (optical axis) of a camera.

In order to solve the above-described problem, a control device according to an aspect of the present disclosure is a control device that performs attitude determination of a camera mounted on a vehicle, the control device being configured to determine an attitude of the vehicle, and not perform the attitude determination of the camera in a case where the attitude of the vehicle is a specific attitude.

In addition, a non-transitory storage medium storing a computer program according to an aspect of the present disclosure causes a computer to execute determining an attitude of a vehicle, and not performing attitude determination of a camera mounted on the vehicle in a case where the attitude of the vehicle is a specific attitude.

According to the aspects of the present disclosure, it is possible to suppress erroneous determination that an abnormality occurs even though an abnormality does not occur in an attitude (optical axis) of a camera.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle according to an embodiment of the present disclosure; and

FIG. 2 is a flowchart illustrating attitude determination processing of an external camera according to the embodiment of the present disclosure.

### DETAILED DESCRIPTION OF EMBODIMENTS

Hereinafter, an embodiment of the present disclosure will be described in detail with reference to the drawings. In the following description, the same reference numerals are given to the same constituent elements.

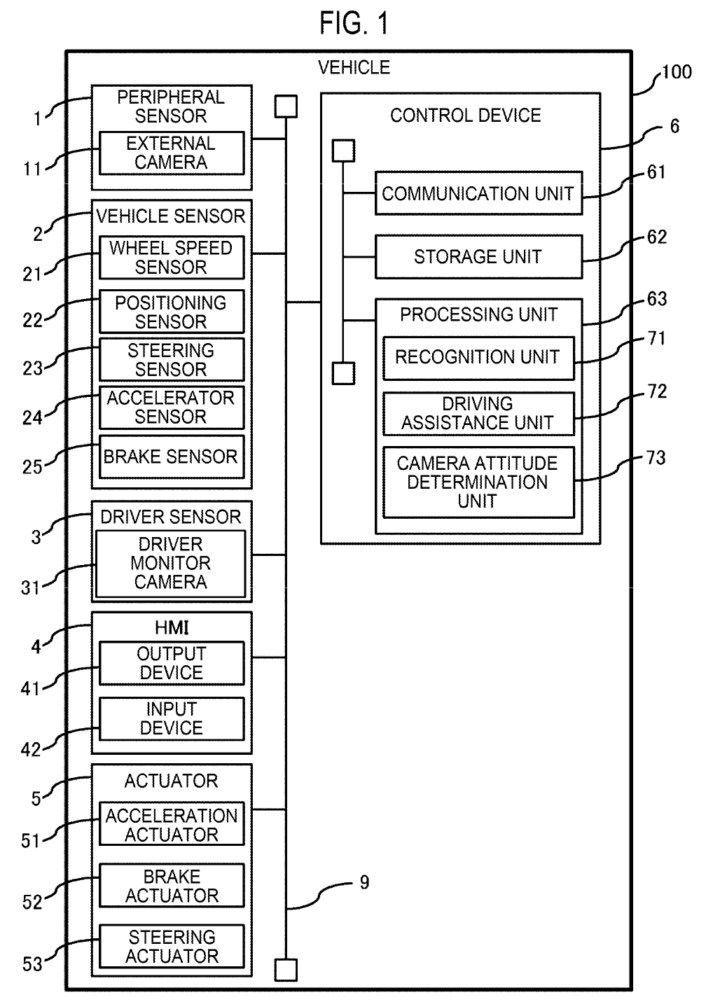

FIG. 1 is a schematic configuration diagram of a vehicle 100 according to the embodiment of the present disclosure.

The vehicle 100 includes a peripheral sensor 1, a vehicle sensor 2, a driver sensor 3, a human machine interface (HMI) 4, an actuator 5, and a control device 6. The peripheral sensor 1, the vehicle sensor 2, the driver sensor 3, the HMI 4, the actuator 5, and the control device 6 are communicably connected to each other via an in-vehicle network 9 that conforms to a standard such as a controller area network.

The peripheral sensor 1 is a sensor for generating peripheral data representing a situation around the vehicle 100. The vehicle 100 according to the present embodiment includes one or a plurality of external cameras 11 for imaging a periphery of the vehicle 100 as the peripheral sensor 1. The external camera 11 images the periphery of the vehicle 100 at a predetermined frame rate (for example, 10 [Hz] to 40 [Hz]) and generates a peripheral image (for example, an image in which the front of the vehicle 100 is imaged) in which the periphery of the vehicle 100 is imaged. Each time the external camera 11 generates the peripheral image, the external camera 11 transmits the generated peripheral image to the control device 6 as the peripheral data.

In addition to the external camera 11, the vehicle 100 may include a distance measurement sensor that measures a distance to an object or a landmark present around the vehicle 100, as the peripheral sensor 1. Examples of the distance measurement sensor include a light detection and ranging (LiDAR) that emits laser light and measures a distance based on reflected light, and a millimeter wave radar sensor that emits radio waves and measures a distance based on reflected waves.

The vehicle sensor 2 is a sensor for acquiring vehicle data representing a state of the vehicle 100. The vehicle 100 according to the present embodiment includes a wheel speed sensor 21, a positioning sensor 22, a steering sensor 23, an accelerator sensor 24, a brake sensor 25, and the like as the vehicle sensor 2. The wheel speed sensor 21 acquires wheel speed data indicating a rotation speed (wheel speed) of each wheel of the vehicle 100. The positioning sensor 22 acquires current position data indicating a current position of the vehicle 100, such as latitude and longitude. The steering sensor 23 acquires

data related to a steering operation such as steering grip, steering torque, and a steering angle. The accelerator sensor 24 acquires data related to an accelerator operation such as a depression amount of an accelerator pedal. The brake sensor 25 acquires data related to a brake operation such as detection of an operation input of a brake pedal. However, the vehicle sensor 2 is not limited to these sensors. Each data acquired by the sensors 21 to 25 is transmitted to the control device 6 as the vehicle data.

The driver sensor 3 is a sensor for generating driver data representing a state of a driver. The vehicle 100 according to the present embodiment includes a driver monitor camera 31 for imaging a driver's appearance including a face of the driver as the driver sensor 3. The driver monitor camera 31 images the appearance of the driver at a predetermined frame rate (for example, 10 [Hz] to 40 [Hz]) and generates an appearance image in which the appearance of the driver is imaged. Each time the driver monitor camera 31 generates the appearance image, the driver monitor camera 31 transmits the generated appearance image to the control device 6 as the driver data.

The HMI 4 is a user interface for exchanging information between the vehicle 100 and an occupant thereof. The HMI 4 includes an output device 41 for notifying the vehicle occupant through a body sensation (for example, visual, auditory, and tactile sensations) of the vehicle occupant, and an input device 42 for the vehicle occupant to perform an input operation or a response operation. The output device 41 is, for example, a display (for example, a meter display, a center display, a head-up display, or the like), a speaker, or the like. The input device 42 is, for example, a touch panel, a microphone, or the like.

The HMI 4 notifies the vehicle occupant of information corresponding to an output signal received from the control device 6 via the output device 41, and transmits the data input by the vehicle occupant via the input device 42 to the control device 6.

The HMI 4 may be a device that is mounted in advance in the vehicle 100, or may be a terminal such as a smartphone owned by the vehicle occupant (driver and passenger). In the latter case, for example, the information may be exchanged by performing short-range wireless communication between the vehicle 100 and the terminal of the vehicle occupant. In addition, communication may be performed between the terminal of the vehicle occupant and an external server (not shown), and the information may be exchanged indirectly via the server.

The actuator 5 is a device used for traveling control of the vehicle 100. The vehicle 100 according to the present embodiment includes an acceleration actuator 51, a brake actuator 52, and a steering actuator 53 as the actuator 5. The acceleration actuator 51 is an actuator that performs acceleration control of the vehicle 100, and is, for example, at least one of an engine or a motor. The brake actuator 52 is an actuator that performs brake control of the vehicle 100, and is, for example, a hydraulic actuator. The steering actuator 53 is an actuator that performs steering control of the vehicle 100, and is, for example, a steering motor.

The control device 6 is an electronic control unit (ECU) including a communication unit 61, a storage unit 62, and a processing unit 63.

The communication unit 61 includes an interface circuit for connecting the control device 6 to the in-vehicle network 9. The communication unit 61 supplies various types of data received from the outside to the processing unit 63. In addition, the communication unit 61 outputs various types of signals output from the processing unit 63 to the outside.

The storage unit 62 includes a storage medium such as a hard disk drive (HDD), a solid disk drive (SSD), and a semiconductor memory, and stores various computer programs, data, and the like used for processing in the processing unit 63.

The processing unit 63 includes one or a plurality of central processing units (CPUs) and a peripheral circuit thereof, and executes various computer programs stored in the storage unit 62. The processing unit 63 is, for example, a processor. The processing unit 63 may further include another arithmetic circuit such as a logic operation unit, a numerical operation unit, or a graphic processing unit. The processing unit 63 executes processing in accordance with a computer program to function as a recognition unit 71, a driving assistance unit 72, and a camera attitude determination unit 73, and operates as a functional unit (module) that realizes a predetermined function. In the following description, in a case where processing is described with each functional unit 71 to 73 as a subject, it is indicated that the processing unit 63 executes a program that realizes each functional unit 71 to 73.

Hereinafter, a content of specific processing executed in the control device 6 will be described. That is, a content of each functional unit 71 to 73 realized by the processing unit 63 executing processing in accordance with the computer program will be described.

The recognition unit 71 recognizes an object and a landmark around the vehicle 100. The recognition unit 71 recognizes an object such as another vehicle, a two-wheeled vehicle, or a pedestrian, and a landmark such as a curb or a fence or other similar structure (hereinafter, referred to as “partition structure”) or a road sign (for example, a partition line defining a traveling lane) in the peripheral image by sequentially inputting the peripheral image received from the external camera 11 to an identifier, for example. The identifier can be, for example, a convolutional neural network (CNN) having a plurality of convolutional layers connected in series from an input side to an output side. In addition, the recognition unit 71 calculates a distance from the vehicle 100 to the object and the landmark and calculates a position of the object and the landmark by using, for example, a standard size of the object and the landmark and a size of the recognized object and landmark. The standard size of the object and the landmark is stored in the storage unit 62 for each type of the object and the landmark. The size of the object and the landmark is recognized in the peripheral image. The method of recognizing the object and the landmark is not limited to such a method, and may be recognized by various known methods.

The driving assistance unit 72 controls the actuator 5 based on the object and the landmark recognized by the recognition unit 71 to perform driving assistance with traveling control of the vehicle 100. In the present embodiment, the driving assistance unit 72 can perform the driving assistance with the traveling control of the vehicle 100 at a driving control level of level 3 defined by the Society of Automotive Engineers (SAE). The driving control level of level 3 is a driving control level that does not require the driver to operate each of the actuators 51 to 53 and to monitor the surroundings. In addition, the driving assistance unit 72 can perform the driving assistance with the traveling control of the vehicle 100 at a driving control level in which the driver is involved in driving of the vehicle 100, for example, a driving control level of level 1 or level 2 defined by SAE. In addition, the driving assistance unit 72 performs appropriate display or warning to the driver via the HMI 4 based on the object and the landmark recognized by the recognition unit 71.

The camera attitude determination unit 73 determines whether the attitude (optical axis) of the external camera 11 is normal. In a case where the attitude of the external camera 11 with respect to the vehicle 100 changes due to a defective assembly or detachment of the external camera 11, the attitude of the external camera 11 with respect to the road surface also changes. Therefore, it may be impossible to image a region that should be imaged by the external camera 11, and it may be impossible to recognize the object and the landmark around the vehicle 100 by the recognition unit. Therefore, the camera attitude determination unit 73 according to the present embodiment calculates an intersection between a translation axis indicating a direction of a movement vector of the external camera 11 and a projection image plane of the external camera 11, that is, a position of a focus of expansion (FOE) of the external camera 11. Then, the camera attitude determination unit 73 determines whether the position of the FOE is within a predetermined normal range (for example, a central region of the projection image plane) on the projection image plane.

A translation axis of the external camera 11 fixed to the vehicle 100 basically matches a traveling direction (vehicle front-rear axis) of the vehicle 100. Therefore, in a case where the vehicle 100 basically travels on a flat road, the position of the FOE on the projection image plane in a case where the attitude of the external camera 11 is normal is basically constant. Although the position of the FOE on the projection image plane changes to some extent due to a tilt of the road surface or the like, in a case where the attitude of the external camera 11 is normal, the position of the FOE is within a predetermined range on the projection image plane. Therefore, by determining whether the position of the FOE is within a predetermined normal range on the projection image plane, it is possible to determine whether the attitude of the external camera 11 is normal.

However, for example, in a case of being towed by a towing vehicle such as a tow truck, the vehicle 100 is in an attitude in which the front wheel or the rear wheel is lifted (hereinafter, referred to as a “vehicle towing attitude”), so that the attitude of the external camera 11 with respect to the road surface changes even though the attitude of the external camera 11 with respect to the vehicle 100 is normal. Therefore, the position of the FOE on the projection image plane changes, and the position of the FOE may be out of the normal range.

Therefore, in the present embodiment, in a case where the attitude of the vehicle 100 is a specific attitude in which the attitude of the external camera with respect to the vehicle 100 does not change and the attitude of the external camera with respect to the road surface changes, such as the vehicle towing attitude, the determination of whether the attitude (optical axis) of the external camera 11 is normal is not performed.

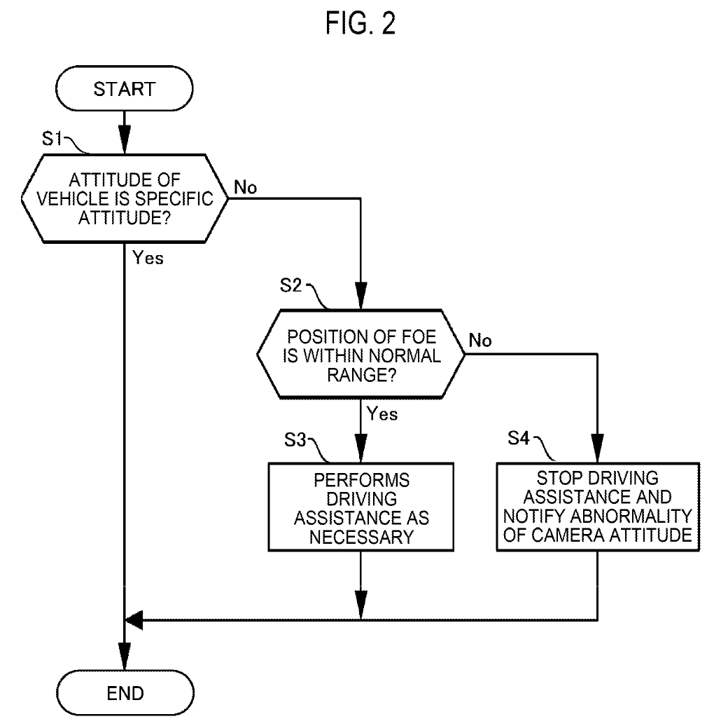

FIG. 2 is a flowchart illustrating the attitude determination processing of the external camera 11 according to the present embodiment performed by the control device 6. The control device 6 repeatedly executes the present routine at a predetermined operation cycle while the imaging by the external camera 11 is being performed.

In S1, the control device 6 determines whether the attitude of the vehicle 100 is a specific attitude in which the attitude of the external camera with respect to the vehicle 100 does not change and the attitude of the external camera with respect to the road surface changes.

In the present embodiment, the control device 6 determines whether the attitude of the vehicle 100 is the vehicle towing attitude in which the front wheel or the rear wheel of the vehicle 100 is lifted. A method of determining whether the attitude of the vehicle 100 is the vehicle towing attitude is not particularly limited. For example, in a case where an abnormality is not detected in the wheel speed sensor 21 of each of the front wheels and the rear wheels on the right and left sides and each wheel speed of the front wheels and the rear wheels on the right and left sides is equal to or greater than a predetermined speed VTH, it can be determined that the attitude of the vehicle 100 is not the vehicle towing attitude. In other words, in a case where an abnormality is not detected in the wheel speed sensor 21 of each of the front wheels and the rear wheels on the right and left sides, in a case where the wheel speed of one of the front wheels and the rear wheels is equal to or greater than the predetermined speed VTH, and the wheel speed of the other of the front wheels and the rear wheels is less than the predetermined speed VTH, it can be determined that the attitude of the vehicle 100 is the vehicle towing attitude. The wheel speed sensor 21 is determined to be abnormal, for example, in a case where the output value continuously indicates an abnormal value.

In a case where the attitude of the vehicle is the specific attitude (the vehicle towing attitude in the present embodiment), the control device 6 ends the present processing without determining whether the attitude of the external camera 11 is normal. On the other hand, in a case where the attitude of the vehicle is not the specific attitude, the control device 6 proceeds to the processing of S2.

In S2, the control device 6 calculates the position of the FOE of the external camera 11 and determines whether the position of the FOE is within a predetermined normal range on the projection image plane. A method of calculating the position of the FOE is not particularly limited. For example, the intersection on the projection image plane in a case where parallel straight lines such as the partition line recognized by the recognition unit 71 are extended to infinity may be calculated as the position of the FOE. The optical flow of the object on the translation axis of the external camera 11 may be calculated using a plurality of temporally continuous peripheral images (time-series images), and the intersection of straight lines obtained by extending the optical flow may be calculated as the position of the FOE. In a case where the position of the FOE is within the normal range (for example, the central region of the projection image plane) on the projection image plane, the control device 6 proceeds to the processing of S3. On the other hand, in a case where the position of the FOE is not within the normal range on the projection image plane, the control device 6 proceeds to the processing of S4.

In S3, the control device 6 performs the driving assistance by the driving assistance unit 72 as necessary without stopping the driving assistance by the driving assistance unit 72. The driving assistance by the driving assistance unit 72 is driving assistance corresponding to the recognition result of the object and the landmark around the vehicle 100 using the peripheral image generated by the external camera 11.

In S4, the control device 6 temporarily stops the driving assistance by the driving assistance unit 72 and performs a notification or a warning for notifying the vehicle occupant via the HMI 4 that there is a concern that the attitude of the external camera 11 is not normal. The driving assistance by the driving assistance unit 72 is driving assistance corresponding to the recognition result of the object and the landmark around the vehicle 100 using the peripheral image generated by the external camera 11.

The control device 6 that performs the attitude determination (optical axis determination) of the external camera 11 (camera) mounted on the vehicle 100 according to the present embodiment determines the attitude of the vehicle 100. The control device 6 is configured to not perform the attitude determination of the external camera 11 in a case where the attitude of the vehicle 100 is the specific attitude.

As a result, in a case where the attitude of the vehicle 100 is an attitude in which erroneous determination is likely to occur in a case where the attitude determination of the external camera 11 is performed, it is possible to suppress performing the attitude determination of the external camera 11. Therefore, it is possible to suppress erroneous determination from occurring in a case where the attitude determination of the external camera 11 is performed.

The specific attitude is an attitude in which the attitude of the external camera 11 with respect to the vehicle 100 does not change and the attitude of the external camera 11 with respect to the road surface changes.

In the present embodiment, the control device 6 is configured to determine that the attitude of the vehicle 100 is the specific attitude in a case where an abnormality is not detected in the wheel speed sensor 21 that detects the wheel speed of each of the front wheels and the rear wheels of the vehicle 100, the wheel speed of one of the front wheels and the rear wheels is equal to or greater than a predetermined speed VTH, and the wheel speed of the other of the front wheels and the rear wheels is less than the predetermined speed VTH.

As a result, in a case where the attitude of the vehicle 100 is the vehicle towing attitude in which erroneous determination is likely to occur in a case where the attitude determination of the external camera 11 is performed, it is possible to suppress the attitude determination of the external camera 11 from being performed.

In addition, the control device 6 according to the present embodiment is configured to perform the attitude determination of the external camera 11 based on whether the position of the FOE of the external camera 11 is within a predetermined normal range on the projection image plane of the external camera 11 in a case where the attitude of the vehicle 100 is not the specific attitude.

As a result, in a case where the attitude of the vehicle 100 is an attitude in which erroneous determination is unlikely to occur in a case where the attitude determination of the external camera 11 is performed, the attitude (optical axis) of the external camera 11 can be accurately determined.

Although the embodiments of the present disclosure have been described above, the above embodiments merely show a part of application examples of the present disclosure, and are not intended to limit the technical scope of the present disclosure to the specific configurations of the embodiments.

For example, in the embodiment, in S1 of the flowchart of FIG. 2, it is determined whether an abnormality is detected in any of the wheel speed sensors 21 of the front wheels and the rear wheels. In a case where an abnormality is detected in any of the wheel speed sensors 21 of the front wheels and the rear wheels, the processing may be ended without determining whether the attitude of the external camera 11 is normal regardless of the wheel speed of one of the front wheels and the rear wheels.

In addition, for example, in the embodiment, the computer program executed in the control device 6 may be provided in a form of being recorded in a computer-readable portable recording medium such as a semiconductor memory, a magnetic recording medium, or an optical recording medium. For example, in the embodiment, the computer program executed in the control device 6 may be provided as a computer program product.

What is claimed is:

1. A control device that performs attitude determination of a camera mounted on a vehicle, the control device being configured to
determine an attitude of the vehicle, and
not perform the attitude determination of the camera in a case where the attitude of the vehicle is a specific attitude.

2. The control device according to claim 1, wherein the specific attitude is an attitude in which an attitude of the camera with respect to the vehicle remains unchanged while the attitude of the camera with respect to a road surface changes.

3. The control device according to claim 1, wherein the control device is configured to determine that the attitude of the vehicle is the specific attitude when an abnormality is not detected in wheel speed sensors configured to detect wheel speeds of front wheels and rear wheels of the vehicle, and when a wheel speed of one of the front wheels and the rear wheels is equal to or greater than a predetermined speed, while a wheel speed of the other of the front wheels and the rear wheels is less than the predetermined speed.

4. The control device according to claim 1, wherein the control device is configured to perform, when the attitude of the vehicle is not the specific attitude, the attitude determination of the camera based on whether a position of a focus of expansion (FOE) of the camera falls within a predetermined normal range on a projection image plane of the camera.

5. A non-transitory storage medium storing a computer program that causes a computer to execute:
determining an attitude of a vehicle; and
not performing attitude determination of a camera mounted on the vehicle in a case where the attitude of the vehicle is a specific attitude.
